(19) United States
(12) Patent Application Publication
(10) Pub. No.: US 2003/0099743 A1
(43) Pub. Date: May 29, 2003

(54) Method of inhibiting sprouting in plant products

(76) Inventors: Richard R. Brey, Pocatello, ID (US); Terry D. Miller, Rupert, ID (US); Frank Harmon, Pocatello, ID (US); Bruce Mitchell, Oakley, ID (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/266,078

(22) Filed: Oct. 7, 2002

Related U.S. Application Data
(60) Provisional application No. 60/327,637, filed on Oct. 5, 2001.

(51) Int. Cl. A21D 2/00; A23G 1/00; A23L 1/00; A23B 4/00; A22C 5/00

(52) U.S. Cl. 426/132

(57) ABSTRACT

The present invention provides a method of inhibiting the sprouting of a plant product by exposing the plant product to a low dose of high-speed electron irradiation at a high dose rate. More specifically, the plant product is exposed a dose of high-speed electron irradiation sufficient to inhibit cell division of its meristematic cells. However, the dose is insufficient to substantially damage the other non-meristematic cells of the plant product. A suitable dose may range from 2.5 to 50 kilorads. The dose rate is also sufficient to inhibit cell division in the meristematic cells of the plant product, and insufficient to substantially damage the non-meristematic cells of the plant product. A suitable dose rate is greater than 10⁶ rads per second. The present invention also includes a plant product treated by the above method.

### CROSS-REFERENCE TO RELATED APPLICATION

This application claims the benefit of prior U.S. Provisional Patent Application No. 60/327,637, filed on Oct. 5, 2001, the contents of which are incorporated herein by reference to the extent that the disclosure contained therein is not inconsistent with the present application.

### FIELD OF THE INVENTION

This invention relates generally to methods of inhibiting sprouting or regrowth in plant products such as vegetables, fruits, and grains, and more specifically, to the treatment of the plant products with a low dose of high-speed electron irradiation delivered at a high instantaneous dose rate to prevent sprouting or regrowth while not substantially damaging the non-meristematic cells of the plant products.

### BACKGROUND OF THE INVENTION

For the purposes of this application, the term “plant product” refers to vegetables, fruits, and grains. The storage of plant products is complicated by several factors inherent to these products including sprouting, regrowth, and decay. Because sprouting and regrowth consume some of the energy stored within the plant product, it is desirable to inhibit these processes. Similarly, if a plant product is injured, some of the energy (such as sugar or starch) stored in the plant product, may be consumed or converted to repair the injury. Ideally, the sprout or regrowth inhibition method chosen will not increase the likelihood of decay.

As an example of the relationship between sprouting, regrowth, and decay, the storage of sugar beets will be discussed in some detail. To prevent sugar beets from regrowing foliage during storage before processing, they are typically “crowned.” Crowning refers to cutting off a portion of the top of the root (called the crown) from the sugar beet. Because crowning injures the sugar beet, crowning creates an opportunity for plant pathogens to invade the sugar beet. To further complicate matters, sugar beets are stacked atop one another in piles. Both top regrowth and decay generate heat that creates environmental conditions that accelerate decay and regrowth in neighboring beets in the pile. Both processes cause a loss of energy in the form of sugar. Furthermore, when the beets are injured by either decay or crowning they expend energy in the form of sugar repairing theinjury. Lastly, a small amount of sugar is lost by crowning because crowning leaves a portion of the root that contains sugar in the field. If crowning can be avoided, more sugar will be available for later processing providing greater returns to both the grower and the processor. Decay and regrowth may also cause the sugar extraction process to be more difficult and costly. Since the value of a sugar beet is directly proportional to the amount of sugar that can be extracted from that sugar beet, a need exists for a method of preventing regrowth and sprouting in sugar beets so as to reduce the loss of energy in the form of sugar, and so as to eliminate the practice of crowing to increase the total amount of available sugar per sugar beet.

At least two methods are currently available to inhibit sprouting in vegetables. First, herbicides, such as chloreroeham (CIPC) and malechydrazide, may be applied to the plant foliage or stored plant product. While such chemicals may inhibit sprouting, they are effective for only a limited duration and must be reapplied following the expiration of that duration. Furthermore, the EPA regulates these herbicides and has restricted the amount that can be present on the surface of a plant product, such as a potato.

Second, it has been known since the mid-1960s that irradiating a potato will inhibit its sprouting. Irradiation is a process by which materials, such as foodstuffs and plant products, are exposed to radiation in the form of a stream of particles or waves. Currently, at least three types of radiation are used to treat foodstuffs: high-speed electrons, x-rays, and gamma rays. The dose absorbed by the plant product (referred to hereafter as the “dose”) is a function of the rate of exposure (referred to hereafter as the dose rate) and the duration of the exposure. Other factors, such as the probability of energy absorption of the individual materials within the foodstuffs may also affect the level of radiation absorbed. Generally speaking, using irradiation to sterilize foodstuffs requires high doses (approximately 25 kGy or 2500 kilorads) that are typically delivered at high dose rates to reduce exposure times.

The prevention of cell division and therefore regrowth and sprouting requires a lower dose than sterilization. For the purposes of preventing sprouting, the FDA has approved an absorbed dose of up to 2 kGy (or 200 kilorads). This standard was based on a method using gamma ray radiation emanating from a Cobalt-60 source. Using this method, irradiation is delivered at a relatively low dose rate for a period of time sufficient to deliver a dose necessary to inhibit sprout growth. The dose delivered to a potato is typically about 20 kilorads or greater. It has been observed that at a dose of approximately 20 to 25 kilorads there is substantial damage to many of the cells of a potato. In some cases, at this dosage, the plant dies. When an organism is damaged or killed, it may begin to decay. Therefore, the high dose (that is well within the FDA standard) applied by traditional gamma ray irradiation renders the plant products more vulnerable to decay.

When gamma rays are used to irradiate plant products, the plant products are typically processed in batches by containerizing the plant products and exposing the filled containers to the gamma irradiation. Therefore, the radiation penetrates the entire volume of the container and all of its contents. Further, the batch process is time consuming. The low cost of potatoes relative to the processing costs associated with irradiating them has resulted in little use of this process.

Using traditional radioactive sources has additional disadvantages. First, these systems are physically large and typically permanent installations. Second, processes using these sources typically requires a long period of time, such as several hours, to deliver a sufficient dose. Last, the plant product must be moved closer to the radioactive source to increase the instantaneous dose rate. Moving the plant product closer to the source takes time. In the time required to move the plant product close enough to the source to receive a suitable dose rate, the plant product may receive too large of a dose of irradiation.

High-speed electrons offer an alternative to traditional radioactive sources. The use of high-speed electron irradiation to sterilize foodstuffs is well known in the art. For example, both U.S. Pat. No. 6,203,755 (Odland) and U.S. Pat. No. 3,779,706 (Nablo) disclose methods of utilizing high-speed electron irradiation as a means to sterilize materials. Odland is directed toward sterilizing biological tissues derived from animals, while Nablo is directed toward bulk sterilization generally and toward sterilizing foodstuffs in particular. Odland teaches using an absorption dose of 25 kGy to 28 kGy and a dose rate of 7,800 Gy/min (468 kGy/hr). Nablo discloses using a dose rate of 10⁷ rads/sec and a dosage level ranging from a few tenths to several megarads. Nablo also discloses that conventional high-speed irradiation sterilization operates at a rate of 1 to 1000 Gy/sec. All of these techniques deliver dosage levels much higher than is necessary to inhibit sprouting. Furthermore, at these dose levels, the cells of the plant product such as a potato or sugar beet are substantially damaged. Generally speaking, a dose of about 20 kilorads or greater delivered to a potato may result indamage to or the death of potato cells.

While high-speed electron irradiation has been used to sterilize plant products, it has not been used to inhibit sprouting or regrowth. This has been unfortunate because high-speed electron irradiation devices do not require radioactive materials to operate. Furthermore, because an accelerator can be turned on and off like a light bulb, the dose from an accelerator can be delivered in pulses having high instantaneous dose rates. Lastly, electron accelerators may require less physical space than a traditional Cobalt-60 or similar irradiating device using a traditional radioactive source.

Therefore, a need exists for a method of inhibiting sprouting that is not limited in duration requiring reapplication. A need also exists for a method of inhibiting sprouting wherein the plant product absorbs less radiation. Further, a need exists for more cost-effective methods of preventing sprouting. Additionally, a need exists for cost-effective methods of preventing sprouting without causing increased decay.

### SUMMARY OF THE INVENTION

The present invention provides a method of inhibiting sprouting in a plant product by exposing the plant product to a low dose of high-speed electron irradiation at a high dose rate. More specifically, the plant product is exposed to a dose of high-speed electron irradiation sufficient to inhibit cell division of its meristematic cells. However, the dose is insufficient to substantially damage the other non-meristematic cells of the plant product. A suitable dose may range from 2.5 to 50 kilorads. The dose rate is also sufficient to inhibit cell division in the meristematic cells of the plant product, and insufficient to substantially damage its non-meristematic cells. A suitable dose rate is greater than 10⁶ rads per second. Using the present method, it may not be necessary to penetrate the entire volume of the plant product with irradiation because the meristematic cells are typically located in specific regions of the plant product. In many cases, the meristematic cells will be located on or near the surface of the plant product. The present invention also includes a plant product treated by the aforementioned method.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic, side perspective view of one embodiment of an apparatus constructed to perform the method of the present invention;

FIG. 2 is a schematic, side cross-sectional view of the apparatus depicted in FIG. 1;

FIG. 3A is a graph depicting an exemplary absorbed dose versus absorbed dose rate operational regime for potatoes constructed in accordance with one embodiment of the present invention; and

FIG. 3B is a graph depicting an exemplary absorbed dose versus absorbed dose rate operational regime for sugar beets constructed in accordance with one embodiment of the present invention.

### DETAILED DESCRIPTION OF THE PREFERRED EMBODIMENT

According to the Law of Bergonie' and Tribondeau, sensitivity to radiation depends on the number of undifferentiated cells in the tissue, the degree of mitotic activity in the tissue, and the length of time cells of the tissue stay in active proliferation. As a general rule, sensitivity to irradiation is directly correlated to the rate of cell division. In other words, cells that divide more frequently are more sensitive to radiation. Meristematic cells are undifferentiated plant cells that are responsible for plant growth. Because these cells divide more frequently than other plant cells, they are more sensitive to radiation. Because sprouting is the result of meristematic cell division, sprout inhibition may be achieved by inhibiting the cell division of the meristematic cells. The non-meristematic cells do not play an active role during sprouting.

As discussed above, it has been known for many years that sprouting may be inhibited by exposing a plant product to radiation. However, none of the prior art methods focused on inhibiting the cell division of the meristematic cells while leaving the non-meristematic cells of the plant product relatively undamaged. Instead, these methods focused on delivering doses and does levels that would uniformly affect the plant cells but not render the plant product completely unsuitable for its intended use.

The location of the meristematic cells varies depending on the nature of the plant product. For example, the meristematic cells of a potato may be located in and around the eyes of the potato. As another example, the meristematic cells of a sugar beets and other vegetables such as carrots and onions may be located in and around the crown from which the top growth of the vegetable emerges. Further, the meristematic cells may be located on the surface of the plant products and/or extend inwardly into the volume of the plant product. For example, the meristematic cells of a potato may extend up to one half inch into the volume of the potato. Consequently, radiation need not penetrate the entire volume of the potato to stop it from sprouting because the meristematic cells are located in first half an inch of the potato.

Generally, non-meristematic cells are located more centrally in the volume of the plant product than the meristematic cells. For the purposes of preventing sprouting, it is not necessary to expose these cells to radiation. In fact, such exposure of the non-meristematic cells to radiation may substantially damage them, resulting in decay. Specifically, cells exposed to large quantities of radiation may die. Once a cell dies, it begins to decay, resulting in damage to the plant product. The lower the dose absorbed by the plant product, and the faster the dose is applied, the less likely cellular damage will occur.

As mentioned above, non-meristematic cells are less sensitive to irradiation than meristematic cells. Therefore, it is possible to inhibit the cell division of the meristematic cells and leave the non-meristematic cells unaffected. The present invention offers a method of using high-speed electron radiation to inhibit sprouting in plant products by inhibiting the cell division of the meristematic cells without substantially damaging the non-meristematic cells. This may be accomplished in at least two ways.

First, as discussed above, the meristematic cells are found at or near the surface of most plant products. Therefore, the depth of penetration of the high-speed electron beam may be set to penetrate the plant product to only the depth necessary to prevent the meristematic cells from dividing. Naturally, some non-meristematic cells will receive a dose of irradiation. For this reason, the dosage level should be sufficiently large to alter the meristematic cells so that they will not divide and low enough so that the non-meristematic cells remain unaltered by the irradiation treatment. Using this method, irradiation from an accelerator contacts the outer surface of the plant product and penetrates the meristematic cells. While the depth and location of the meristematic cells may vary depending upon the plant product irradiated, generally speaking, the meristematic cells may be found within the first one-quarter to one-half inch of the plant product. Because the meristematic cells occur along the outer portion of the volume of the plant product, it may be desirable to rotate the plant product as it is being irradiated. Alternatively, it may be desirable to locate two or more accelerators in positions that will expose a sufficient portion of the meristematic cells to the radiation.

Second, it has been observed that low doses of radiation delivered at a high dose rate inhibit the meristematic cells from dividing while leaving the non-meristematic cells unaffected. Using traditional irradiation methods, the dose level delivered is typically around 20 kilorads delivered at a low instantaneous dose rate, such as 10,000 rads per minute. Further, the time averaged dose rate and instantaneous dose rate are the same for traditional radioactive source irradiation. In accordance with method of the present invention, 2.5 to 50 kilorads of irradiation may be delivered to the plant product at an instantaneous dose rate of at least 10⁶ rads per second. A plant product irradiated in this manner will include altered meristematic cells that may no longer divide and relatively undamaged non-meristematic cells. Further, because the radiation is delivered in a relatively short period of time, the dose may be administered in a continuous manner as the plant products travel along a conveyer belt.

When discussing dosage rates for high-speed electron radiation herein, the values provided are instantaneous dosage rates, and not the time averaged dose rate. Furthermore, when discussing high-speed electron radiation delivered in pulses, the pulsed instantaneous dose rate is used. As a non-limiting example, the pulse rate may include about one microsecond at frequencies from 100 to 300 hertz with various current pulse amplitudes on the order of about 0.1 ampere. In another embodiment, the pulse rate may range from a tenth of a microsecond to several microseconds. In another embodiment, the pulse rate may range from 30 to 500 hertz. In yet another embodiment, the current pulse amplitude may range from 10 to 40 milliamperes. While examples of suitable pulse durations, pulse rates, and pulse amplitudes have been provided herein, it is apparent to one of ordinary skill in the art that alternate parameters may be used to deliver the desired dose at the desired dose rate.

As mentioned above, an effective dose level to prevent sprouting and regrowth is less than an effective dose level for sterilization. For example, potatoes and sugar beets are sterilized at about 500 kilorads. However, a dose as low as 2.5 to 5 kilorads has been shown to inhibit sprouting in potatoes and sugar beets. In one embodiment, the method of the invention requires delivering a dose between 2.5 to 50 kilorads to plant products such as sugar beets and potatoes at a rate of at least 10⁶ rads per second. No deleterious effects were observed for dose rates higher than 10⁶ rads per second delivering the same dosage level. Both potatoes and sugar beets treated using this method may experience inhibited regrowth and sprouting of the green top material without undue damage to plant tissue as determined by nitrate concentration, conductivity, and sugar content. In another embodiment, a dose between 5 kilorads to 10 kilorads may be delivered to a plant product such as a potato or sugar beet at a rate of at least 10⁶ rads per second to achieve similar favorable results.

As yet another example, 2,500 rads may be delivered in 23.5 seconds for a time averaged rate of 106.4 rads/second. The pulse repetition rate used may be 150 pulses/second so that 0.71 rads/pulse may be delivered. Pulses of 2 microseconds in duration may be used to achieve an instantaneous dose rate of about 360,000 rads/second. The time averaged dose rate may be modified by adjusting the pulse width and/or pulse rate.

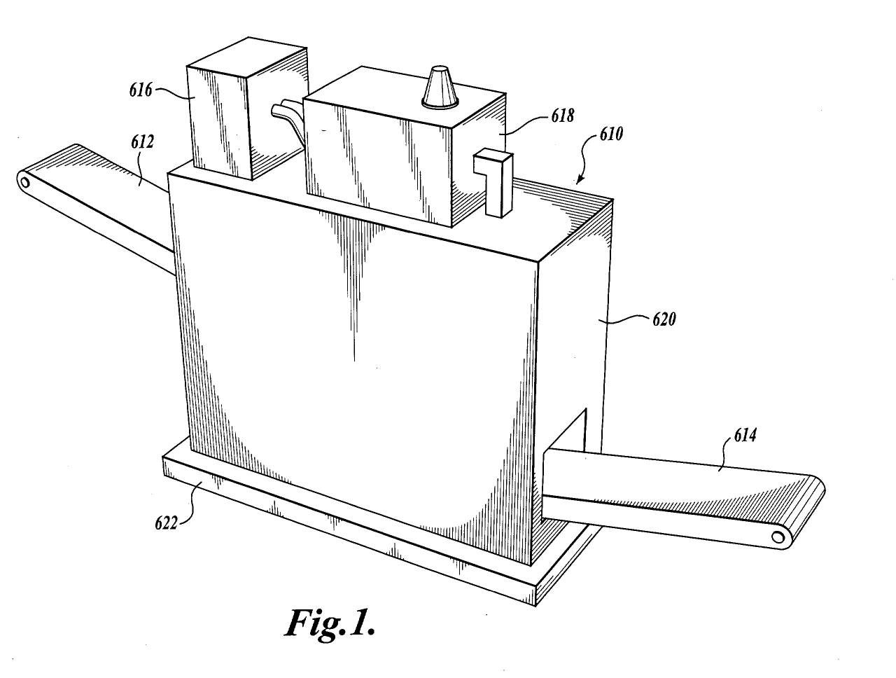

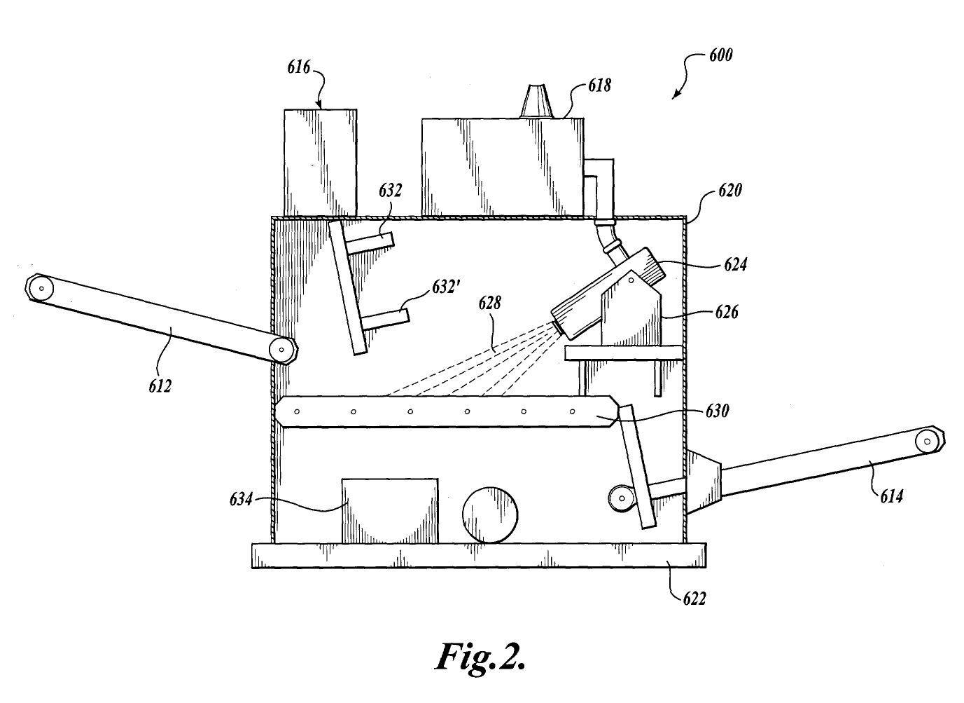

Because a high-speed electron linear accelerator may be used to provide the high-speed electron radiation component of the present invention, a device much smaller than one used in traditional radioactive source irradiation (e.g., Cobalt-60) may be used to deliver a dose to the plant product. Such a device may be suitably constructed to be portable. FIGS. 1 and 2 depict a non-limiting example of an apparatus constructed to perform the method of the invention. While a portable accelerator system 600 is presented herein to further illustrate the present invention, it is appreciated by those of ordinary skill in the art that other apparatuses, including accelerator systems that are not portable, may be constructed to perform the method of the present invention. Portable accelerator system 600 has raw product inlet conveyor 612 and treated product outlet conveyor 614. Also visible in FIG. 2 are chiller 616 and microwave source/power supply 618 on top of protective cabinet 620. Cabinet 620 is mounted on cabinet frame 622 which may be fitted with optional wheels or skids (not shown) for portability of accelerator system 600.

Inside protective cabinet 620 is accelerator 624 supported by accelerator frame 626. Accelerator 624 produces accelerator beam 628 that intercepts or impinges on the top of product roller table 630. Accelerator 624 may be any high-speed electron accelerator known in the art operating within a range permitted by law, such as a 1 to 4 MeV linear accelerator. As a non-limiting example, in the United States, an accelerator up to 10 MeV may be used to deliver electron radiation. However, it is readily appreciated by those skilled in the art that more powerful accelerators may be used. Additionally, other types of accelerators such as Dynamitrons and Van de Graaff generators are suitable for creating an electron beam and are therefore, within the scope of the present invention. The electron beam may be rastered so that it will spread out to span the entire width of the product roller table 630. Roller table 630 extends between the discharge end of input conveyor 612 and the pick-up end of output conveyor 614 within cabinet 620. Also within protective cabinet 620 are radiation buffers 632 and 632′, and accelerator beam monitor 634.

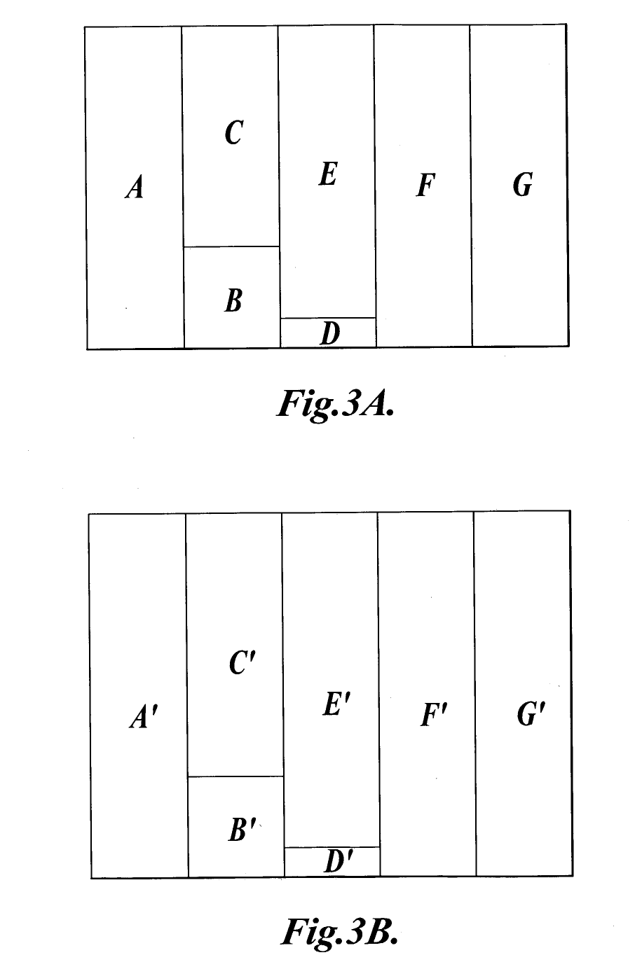

FIG. 3A is a graph of the absorbed dose versus absorbed dose rate operational regime for potatoes constructed in accordance with one embodiment of the present invention. The X-axis of FIG. 3A is the total absorbed dose. The Y-axis is absorbed dose rate (as mentioned above this value refers to the instantaneous or pulsed instanteous dose rate). At very low dose, regardless of the dose rate, no noticeable change is achieved because an insufficient dose was applied to the plant product. Reference letter A within FIG. 3A designates this region of insufficient absorbed dose. As a non-limiting example, for potatoes doses below 2.5 kilorads (0.025 Gy) may be insufficient to prevent sprouting.

Region B is also a region where no noticeable change is achieved because the dose is delivered at too low of a dose rate. In other words, the dose level of Region B would be effective if delivered at a higher dose rate. The dose range encompassed by Region B may include 2.5 to 50 kilorads and preferably about 5 kilorads. Experiments have shown that the upper boundary of Region B (i.e., the dose rate at which the dose levels of Region B become effective) may be approximately 10⁶ rads per second.

If the dose rate is increased to that depicted in Region C, cell division of the meristematic cells will be inhibited. It is appreciated by one of ordinary skill in the art that while the border between Regions B and C is depicted as a horizontal line, the border between these regions may in fact be non-linear or sloped. Region C may be considered an operating envelope where the absorbed dose is delivered at sufficient rate to secure the positive effects of irradiation: cessation of sprouting and greening through the inhibition of meristematic cell division, without the deleterious consequences (i.e., damaging non-meristematic cells).

Region D depicts the dose rate and dose level typically delivered by a traditional gamma ray (Cobalt-60) system. As discussed above, a gamma ray system may operate at approximately 10,000 rads per minute (60 Gray/hour) and deliver around a 20 kilorads dose. Region E represents dose rates too high for a traditional gamma ray system (without adding additional radioactive manner), but within the range achievable by high-speed electron irradiation. Therefore, the “operating envelope” of the present invention may also encompass Region E.

Region F represents the dosage at which non-meristematic cells become substantially damaged. As discussed above, in actual application, Region D may extend into this region. Region D may include doses of about 20 to 50 kilorads. Region G represents the circumstance under which the total applied dose is high enough to be capable of sterilizing the product.

It is appreciated by those of ordinary skill in the art that the borders between the Regions A, B, C, D, E, F, and G may overlap. Further, these regions are depicted in a very simplistic manner for illustrative purposes and are in no way intended to represent the relative size or scope of the regions depicted. Further, Regions A, B, C, D, E, F and G may not be square or rectangular in shape. Lastly, the size and location of the regions may change based upon the particular plant product being considered.

FIG. 3B is a graph of the absorbed dose versus the absorbed dose rate operational regime for sugar beets constructed in accordance with one embodiment of the present invention. This graph, like the one depicted in FIG. 3A, is merely an illustration intended to clarify the principals of the present invention and is not intended to convey any quantitative information. In FIG. 3B, the insufficient absorbed dose region is marked as A′. Doses below about 2.5 kilorads have been shown to be ineffective to inhibit sprouting. The region where no noticeable change is achieved because the dose is delivered at too low of a dose rate is marked B′. The dose range encompassed by Region B′ may include 2.5 to 50 kilorads.

The operational regime for sugar beets is marked C′ (as with the FIG. 3A, E′ many also be considered part of the operational regime because the high-speed electron system can operate at these rates). The rate at which Region C′ begins is about 10⁶ rads per second. Preferably Region C′ includes a dose of about 5 to 10 kilorads. Although, as discussed with reference to FIG. 3A, the border between Regions B′ and C′ may not be a horizontal line (or a single dose rate value). Region D′ depicts the dose rate and dose level typically delivered by a traditional gamma ray (Cobalt-60) system. The bounds of this region are generally similar to the bounds discussed with reference to FIG. 3A. Region F′ represents the dosage at which non-meristematic cells become substantially damaged. In sugar beets, the non-meristematic cells become substantially damaged at approximately 20 to 50 kilorads. Lastly, the sterilization region is marked G′. Sterilization, in this case, occurs at the same dose used to sterilize potatoes in FIG. 3A.

Please note that the operational regime for sugar beets marked C′ in FIG. 3B, may be different from the operational regime marked C for potatoes in FIG. 3A. Similarly, other plant products may also have alternate operational regimes.

The method of the present invention has many practical commercial applications. For example, sugar beets may be irradiated according to the present method instead of being crowned. The current method may be applied to potatoes as a more cost effective way of preventing sprouting that is faster and delivers a smaller dose. Other vegetables, such as onions, carrots, garlic, parsnips, and rutabagas may also benefit for treatment by the present method. Non-tuberous vegetables such as legumes (lima beans, navy beans, and coffee beans,), peas, cucumbers, and okra, and fruits such as pineapples, avocados, tomatoes, bananas, oranges, apples, pears, peaches, cherries, and blue berries, may also benefit from the inhibition of the division of their meristematic cells. Grains such as corn, wheat, barley, etc may be processed according to the present method to prevent them from sprouting. Particularly, genetically modified grains could be rendered unable to sprout, alleviating any concerns that they may be planted.

Another aspect of this invention includes applying the method of the present invention to inhibit greening in potatoes. Potatoes green when exposed to sunlight, causing them to taste bitter. Generally, greening is avoided during storage by reducing exposure to sunlight. Stores that display potatoes on the shelves expose them to sunlight, often causing greening before the potatoes are sold. Exposing the potatoes to low dosages of irradiation delivered at a high instantaneous dose rates may delay greening by about 2 weeks to a month.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method of inhibiting the sprouting of a plant product comprising exposing the plant product to a dose of high-speed electron irradiation sufficient to inhibit cell division in the meristematic cells of the plant product, and insufficient to substantially damage the non-meristematic cells of the plant product;
wherein the dose is delivered to the plant product at a dose rate sufficient to inhibit cell division in the meristematic cells of the plant product, and insufficient to substantially damage the non-meristematic cells of the plant product.

2. The method of claim 1, wherein the dose is between approximately 2.5 and 50 kilorads.

3. The method of claim 1, wherein the dose is between approximately 2.5 and 10 kilorads.

4. The method of claim 1, wherein the dose rate is greater than approximately 10⁶ rads per second.

5. The method of claim 1, wherein the dose of high-speed electron irradiation is delivered as a pulsed stream of high-speed electrons to the plant product.

6. The method of claim 1, wherein the plant product comprises a tuberous vegetable.

7. The method of claim 1, wherein the plant product comprises a potato.

8. The method of claim 1, wherein the plant product comprises a sugar beet.

9. A method of inhibiting the sprouting of a plant product comprising:
exposing the outer surface of the plant product to high-speed electron irradiation at a dose rate greater than approximately 10⁶ rads per second until an irradiated portion of said plant product receives a dose of irradiation sufficient to inhibit the cell division of the meristematic cells therein, wherein said dose of irradiation is insufficient to substantially damage the non-meristematic cells in the irradiated portion.

10. The method of claim 9, wherein the dose of irradiation is between about 2.5 kilorads and about 50 kilorads.

11. The method of claim 9, wherein the dose of irradiation is between about 2.5 kilorads and about 10 kilorads.

12. The method of claim 9, wherein the plant product comprises a tuberous vegetable.

13. The method of claim 9, wherein the plant product comprises a potato.

14. The method of claim 9, wherein the plant product comprises a sugar beet.

15. A plant product treated to inhibit spouting wherein said treatment comprises exposing said plant product to a dose of high-speed electron irradiation sufficient to inhibit cell division of the meristematic cells of the plant product but insufficient to substantially damage the non-meristematic cells of the plant product, wherein said dose of irradiation is delivered at a dose rate sufficient to inhibit cell division of the meristematic cells of the plant product but insufficient to substantially damage the non-meristematic cells of the plant product.

16. The plant product of claim 15, wherein the dose of irradiation ranges from approximately 2.5 kilorads to approximately 50 kilorads.

17. The plant product of claim 15, wherein the dose of irradiation ranges from approximately 2.5 kilorads to approximately 10 kilorads.

18. The plant product of claim 15, wherein the dose rate is at least approximately 10⁶ rads per second.

19. A plant product in which sprouting has been inhabited by exposing the outer surface of the plant product to high-speed electron irradiation at a dose rate greater than approximately 10⁶ rads per second until an irradiated portion of said plant product receives a dose of irradiation insufficient to substantially damage the non-meristematic cells of the plant product, wherein said dose of irradiation is sufficient to inhibit the cell division of the meristematic cells of the plant product.

20. The plant product of claim 19, wherein the dose of irradiation ranges from approximately 2.5 kilorads to approximately 50 kilorads.

21. The plant product of claim 19, wherein the dose of irradiation ranges from approximately 2.5 kilorads to approximately 10 kilorads.
